(19) United States
(12) Patent Application Publication
(10) Pub. No.: US 2011/0079451 A1
(43) Pub. Date: Apr. 7, 2011

(54) Strength Track Bushing

(75) Inventors: Donovan S. Clarke, Hanna City, IL (US); Kevin L. Steiner, Tremont, IL (US)

(73) Assignee: CATERPILLAR, INC., Peoria, IL (US)

(21) Appl. No.: 12/571,984

(22) Filed: Oct. 1, 2009

(51) Int. Cl. B62D 11/00; B62D 55/092

(52) U.S. Cl. 180/6.7; 305/118

(57) ABSTRACT

An improved strength track bushing (150) is disclosed. The bushing (150) may be used as a bearing around a track pin (144) interconnecting shoes (132) of a track (120) on a track-type tractor (100). The bushing (150) may include a hollow cylindrical wall (163) having an inner diameter (166), an outer diameter (176), and an annular lubrication cavity (164) circumnavigating the inner diameter (166) of the hollow cylindrical wall (163). The bushing (150) includes specific dimensional ratios between the width (174) of the cylindrical wall (163), the size of the inner diameter (166), the size of the outer diameter (176), the width (170) of the annular cavity (164), and the depth (172) of the annular cavity (164). By appropriately sizing such dimensions, the strength of the bushing and thus its ability to avoid cracking in use is greatly improved.

### TECHNICAL FIELD

The present disclosure generally relates to bushings and, more particularly, relates to bushings used in linking shoes together on tracks for track-type tractors.

### BACKGROUND

Bushings are a common form of bearing used to connect components together which pivot relative to each other. For example, a typical track for a track-type tractor is formed by a plurality of interlinked shoes. Each shoe may include a flat plate from which a grouser bar outwardly extends. On an inner surface of each shoe a track link may be bolted. Each track link may also include first and second holes and be designed to straddle between two shoes. A track pin is inserted through holes in adjacent and overlapping links to join them together. In order to allow for the links and pins to freely pivot relative to one another a bushing is often around each track pin.

The bushing may be a hollow cylindrical piece of metal or the like having an inner diameter slightly greater than the outer diameter of the track pin, and having an outer diameter slightly less than the inner diameter of the holes in the track links. In order to facilitate long-lasting use of the track, the bushing is often lubricated. In some designs, track pins are hollow and thus form a reservoir for a lubricant such as grease, oil, or a synthetic lubricant. A lubrication channel radially extends outwardly through the cylindrical wall of the track pin toward the bushing. The bushing in such designs includes a lubrication cavity on its inner diameter. Such a cavity typically extends along the majority of the length of the bushing inner diameter and includes a depth of significant size to enable the lubrication to easily be communicated from the track pin reservoir, through the lubrication channel, into the lubrication cavity and along the majority of the bushing to track pin interface.

While effective in terms of lubrication, the provision of such a lubrication cavity, especially one of such relatively large width and depth, comes at the cost of structural strength. As the track forms part of the undercarriage supporting the track-type tractor, all the components of that track must be able to carry and withstand significant loads. For example, track-type tractors may be provided in the form of bulldozers, front-end loaders, excavators or pipelayers weighing tens of thousands of pounds or tons. Ultimately, all of the machine weight, plus the weight of the load the machine is carrying, must be supported by the track, and in turn the internal components of the track. As the interface between the bushing and the track pin typically includes the aforementioned lubrication cavity, the overall strength of the bushing is limited by the size of that cavity. Typically, this has resulted in over-sizing of the bushing wall thickness, but this adds manufacturing cost in terms of materials, and operating cost in terms of fuel economy. Alternatively, the bushing wall thickness can be manufactured at a lesser thickness, but this makes the bushing less strong and more susceptible to cracking and failure. This is particularly so in the case of more recent track-type tractors which employ Center Tread Idlers (CTIs) that input additional load on such bushings.

### SUMMARY OF THE DISCLOSURE

In accordance with one aspect of the disclosure, a bushing is disclosed which comprises a hollow cylindrical wall having an inner diameter and an outer diameter, and an annular cavity extending circumferentially around the inner diameter of the cylindrical wall, the cylindrical wall having a thickness of A and the annular cavity having a width of B, the ratio of A to B being at least about 1 or more to about 1.

In accordance with another aspect of the disclosure, a bushing is disclosed having a hollow cylindrical wall with an inner diameter, an outer diameter, and an annular lubrication recess, the bushing having a Clarke Factor of less than about 1.

In accordance with a still further aspect of the disclosure, a track-type tractor is disclosed comprising a chassis, an engine supported by the chassis, an undercarriage supporting the chassis, the undercarriage including at least one rotatable track operatively connected to the engine, the track including a plurality of shoes, a plurality of track pins linking the shoes together, each track pin including a substantially cylindrical housing having a central reservoir and a lubrication channel extending through the housing, and a bushing surrounding each track pin, each bushing including a substantially cylindrical housing having an annular cavity on an inner diameter, the bushing having a length of F and the annular cavity having a width of B, wherein the ratio of F to B is about 5 or more to about 1.

### BRIEF DESCRIPTION OF THE DRAWINGS

FIG. 1 is a side elevational view of a track-type tractor constructed in accordance with the teachings of the disclosure;

FIG. 2 is an end elevational view the track-type tractor of FIG. 1;

FIG. 3 is an exploded view of a track constructed in accordance with the teachings of the disclosure;

FIG. 4 is a sectional view of a track pin, track link and bushing connection taken along line 4-4 of FIG. 3.

FIG. 5 is a sectional view similar to FIG. 4, but depicting a bushing constructed according to the prior art;

FIG. 6 is a sectional view of the bushing only of FIG. 4;

FIG. 7 is an enlarged sectional view of region 7 of FIG. 6;

FIG. 8 is a chart depicting stress loads in the bushing of FIG. 4; and

FIG. 9 is a chart similar to FIG. 8, but depicting the stress loads in the prior art bushing of FIG. 5.

### DETAILED DESCRIPTION

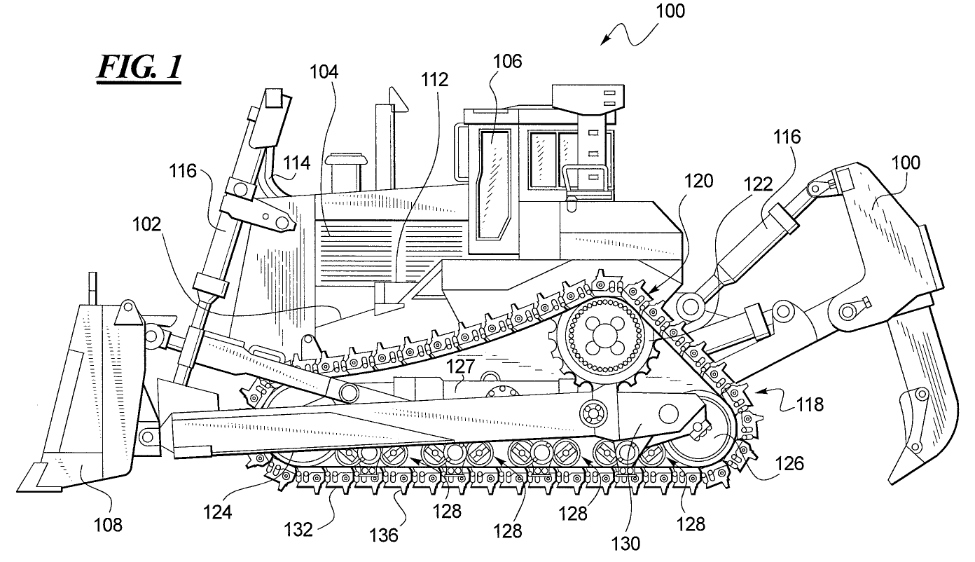

Referring now to the drawings, and with specific reference to FIG. 1, a track-type tractor constructed in accordance with the present disclosure is generally referred to by reference numeral 100. While the following disclosure will be provided with primary reference to a track-type tractor, it is to be understood that the teachings of this disclosure could be used with equal efficacy in conjunction with other track-type machines including, but not limited to, track-type loaders, excavators, pipelayers, and the like.

As shown, the track-type tractor 100 may include a chassis 102 supporting an engine 104. On operator cab or seat 106 may optionally also be supported by the chassis and behind the engine 104. In some embodiments, the track-type tractor 100 may be remotely controlled. Various tools or implements may be mounted on the tractor 100 such as, but not limited to, a blade 108 and a ripper 110. A hydraulic pump 112 may be operatively coupled to the engine 104 to provide pressurized hydraulic fluid via hoses 114 to hydraulic cylinders 116 for lifting or otherwise moving the tools and implements.

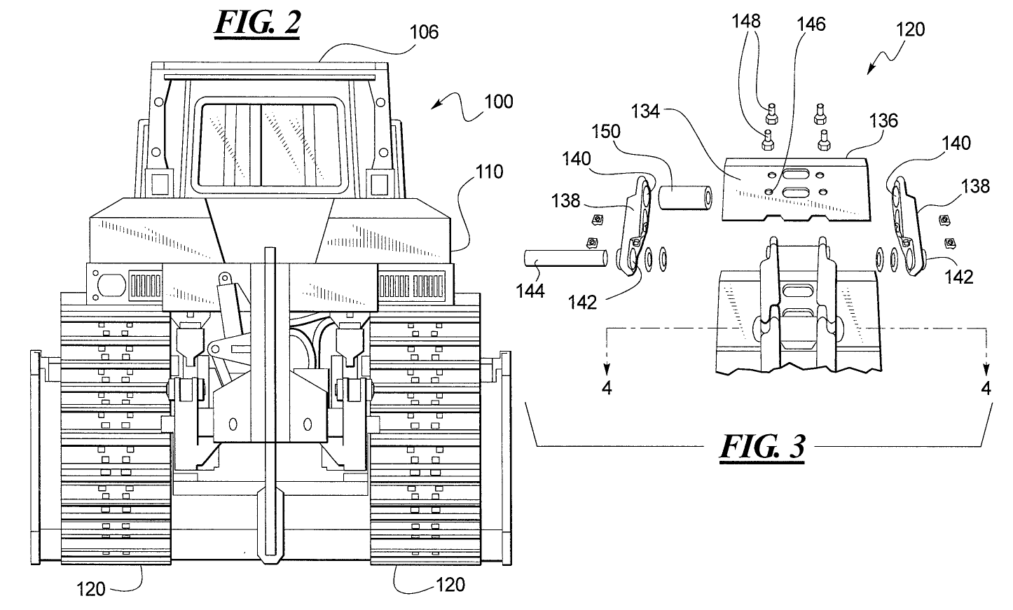

Supporting the chassis is an undercarriage 118. As can be seen, the undercarriage includes a track 120 (typically two tracks laterally flanking the tractor 100 as shown in FIG. 2) for providing locomotion. The track 120 is provided in the form of an endless loop trained around a drive sprocket 122 and first and second idlers 124 and 126 supported by a track roller frame 127. A plurality of rollers or rollers assemblies 128 are provided along a bottom portion 130 of the undercarriage 118. While the undercarriage 118 depicted is a high-drive type undercarriage 118 in that the drive sprocket 122 is provided higher than the idlers 124, 126, it is to be understood that the teachings of this invention can be employed with more conventional oval-shaped drive tracks as well.

With reference now to FIGS. 2 and 3, the track 120 may be formed from a plurality of interlinked shoes 132. Each shoe 132 may include a plate 134 from which a grouser 136 outwardly extends. The shoes 132 may be provided adjacent to one another and be pivotally connected by track links 138 spanning between adjacent shoes 132. Each track link 138 may include fore and aft apertures 140, 142 for passage of track pins 144 therethrough. More specifically, the fore aperture 140 of one track link can be laterally disposed adjacent the aft aperture 142 of another track link 138, and when the track pin 144 is inserted, the two links 138 will be pivotally joined. Additional apertures 146 may be provided in each plate 134 to allow fasteners 148 to fixedly attach the links 138 to the shoes 132.

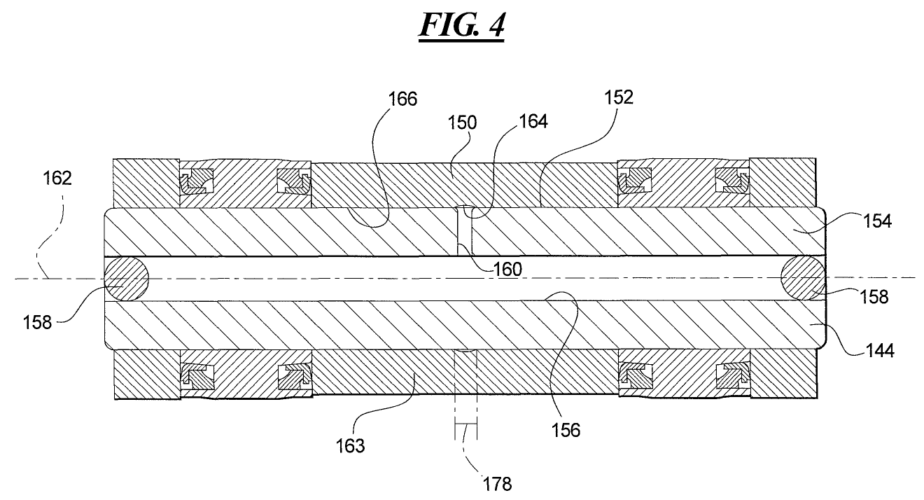

As shown best in the sectional view of FIG. 4, a bushing 150 may be journaled in each aperture 140, 142 to serve as a bearing for the track pins 144. Accordingly, as the track 120 circumnavigates around the drive sprocket 122 and idlers 124, 126 to move the track-type tractor 100, the shoes 132 pivot relative to one other about the track pins 144 with the bushing 150 facilitating such motion. The interface 152 between the bushing 150 and track pin 144 is therefore subject to constant motion and friction and is thus in need of constant lubrication as described in further detail herein.

The track pin 144 may include a substantially cylindrical wall 154 having a hollow interior 156 forming a lubrication reservoir. The hollow interior 156 may be sealed by elastomeric grommets 158 to house a volume of lubricant (not shown) such as but not limited to grease, oil, and synthetic lubricants as known to those of ordinary skill in the art. In order to communicate the lubricant from the reservoir 156 to the interface 152, a lubrication channel 160 may be provided. The lubrication channel 160 may extend radially outward from the reservoir 156 in a direction orthogonal to a longitudinal axis 162 of the track pin 144.

The bushing 150 may include a hollow cylindrical wall 163 which surrounds the track pin 144 in rotatable fashion. In order to allow for sufficient lubricant to exit the lubrication channel 160 and adequately lubricate the interface 152, an annular cavity 164 is provided in an inner diameter 166 of the bushing 150. The annular cavity 164 extends around the entire inner diameter 166 in a position radially outward from an exit 168 of the lubrication channel 160. Accordingly, as lubricant exits reservoir 156, it enters lubrication channel 160 and then exits into annular cavity 164 before being distributed along the length of the bushing 150 at bushing/track pin interface 152.

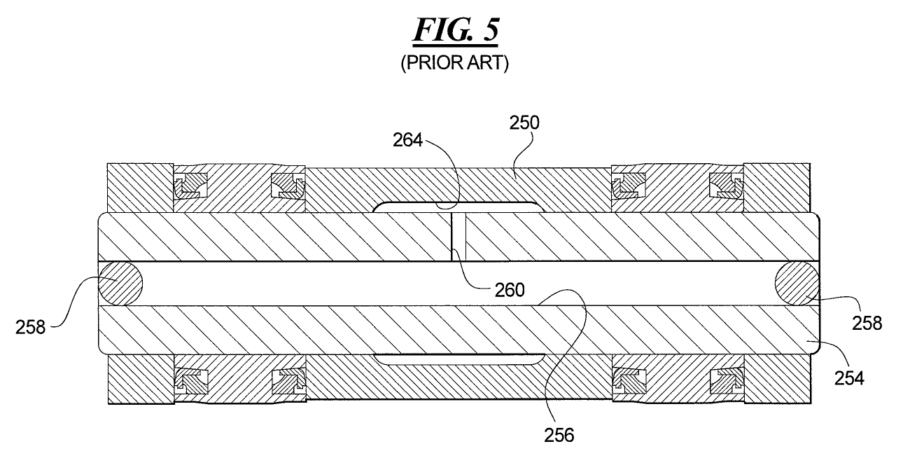

While the foregoing disclosure is consistent with prior art bushings and track structure, the specific cavity 164 and dimensional ratios between the track pin 144 and bushing 150 is not. As indicated above, one deficiency with prior art bushings and track designs has been frequent mechanical failure due to cracking of the bushing. The inventors have found that a reason for this premature cracking has been the stress loads imparted on the bushing at the interface between the bushing and the track pin proximate the lubrication cavity. More specifically, as shown in the prior art bushing of FIG. 5, its lubrication cavity 264 extends along the majority of the length of its bushing 250 and with a significantly deeper profile. While this does allow for sufficient lubricant to enter, it also, the inventors have discovered, weakens the bushing 250 to such a degree that it is commonly susceptible to cracking. This is particularly so with modern track-type tractors with center track idlers which impose a heavy load on such bushings 250.

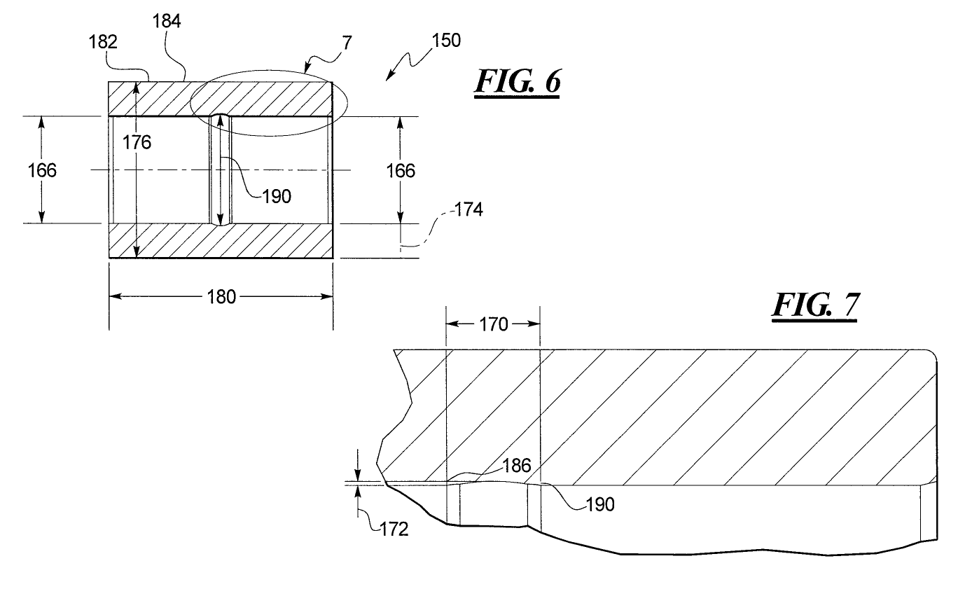

However, with the bushing 150 of the present disclosure, it can be seen that the annular cavity 164 has a much narrower and shallower profile. Namely, as shown best in FIGS. 6 and 7, the cavity 164 includes a width 170 and a depth 172. While the specific dimensions of the width 170 and depth 172 will be dependent on the overall size of the bushing 150 and ultimately the size of the track 120 and track-type tractor 100, the inventors have identified specific ratios between these dimensions which result in a better-performing, stronger, and longer-lasting bushing 150.

One ratio that is of importance is that between the wall thickness 174 of the bushing 150 and the width 170 of the lubrication cavity 164. In one specific embodiment provided by way of non-limiting example only, the width 170 of the lubrication cavity 164 may be about 11 millimeters (mm) and the wall thickness 174 may be about 16.29 mm. Accordingly, the ratio of wall thickness 174 to lubrication cavity width may be about 16.29 to about 11, or about 1.48 to about 1. However, in other embodiments, the bushing 150 still performed better than prior art bushings if the ratio of wall thickness to cavity width was at least about 1 or more to about 1. A ratio of about 1.5 to about 1 may be particularly effective at avoiding cracking. As used herein, “about” is to be understood to mean a value within plus or minus ten percent of the stated value.

Another ratio of importance is that between the wall thickness 174 and the depth 172 of the annular cavity 164. In one specific embodiment, the wall thickness 174 may be about 16.29 mm, and the annular cavity depth 172 may be about 0.54 mm. Accordingly, the ratio of wall thickness 174 to lubrication cavity depth 172 may be about 16.29 to about 0.54, or about 30.16 to about 1. However, in other embodiments, the bushing 150 still performed better than prior art bushings if the ratio was at least about 15 to about 1. A ratio of about 30 to about 1 may be particularly effective at avoiding cracking.

A related ratio to that above is the relationship between the wall thickness 174, the cavity width 164 and the cavity depth. Using the above example, a ratio of about 30 to about 20 to about 1 yields an effective bushing in terms of improved strength. Other ratios of these three variables are certainly possible.

Another ratio of importance is that between the outer diameter 176 of the bushing 150 and the width 170 of the annular cavity 164. In one specific embodiment provided by way of non-limiting example only, the bushing 150 may have an outer diameter 176 of about 83.75 mm, and the width 170 of the lubrication cavity 164 may be about 11 mm. Accordingly, the ratio of outer diameter 176 to channel width 170 may be about 83.75 to about 11, or about 7.61 to about 1. However, in other embodiments, the bushing 150 still performed better than prior art bushings if the ratio was at least about 2 to about 1. A ratio of about 7.5 to about 1 may be particularly effective at avoiding cracking.

A further ratio of importance is that between the inner diameter 166 of the bushing 150 and the width 170 of the annular cavity 164. In one specific embodiment provided by way of non-limiting example only, the bushing 150 may have an inner diameter 166 of about 51.165 mm, and the width 170 of the lubrication cavity 164 may be about 11 mm. Accordingly, the ratio of inner diameter 166 to cavity width 170 may be about 51.165 to about 11, or about 4.65 to about 1. However, in other embodiments, the bushing 150 still performed better than prior art bushings if the ratio was at least about 2 to about 1. A ratio of about 4.5 to about 1 may be particularly effective at avoiding cracking.

A still further ratio of importance is that between the diameter 178 of the lubrication channel 160 and the width 170 of the annular cavity 164. In one specific embodiment provided by way of non-limiting example only, the lubrication channel 160 may have a diameter 178 of about 5.5 mm and the width 170 of the annular cavity 164 may be about 11 mm. Accordingly, one effective ratio of annular cavity width to lubrication channel diameter may be about 2 to about 1. However, in other embodiments, the bushing 150 still performed better than prior art bushings if the ratio was less than about 3 to about 1, including a ratio as low as about 1 to 1.

Yet another ratio of importance is that between the width 170 of the annular cavity 164 and the depth 172 of the annular cavity 164. In one specific embodiment provided by way of non-limiting example only, the width 170 may be 11 mm, and the depth 172 may be 0.54 mm. Accordingly, one effective ratio of annular cavity width to annular cavity depth may be about 20 to about 1. However, in other embodiments, the bushing 150 still performed better than prior art bushings if the ratio was about 30 or less to about 1.

Yet another ratio of importance is that between the width 170 of the annular cavity 164 and the length 180 of the bushing 150. In one specific embodiment provided by way of non-limiting example only, the width 170 may be 11 mm, and the length 180 of the bushing 150 may be 104 mm. Accordingly, one effective ratio of bushing length to annular cavity width may be about 10 to about 1. However, in other embodiments, the bushing 150 still performed better than prior art bushings if the ratio was about 5 or more to about 1. A ratio of about 9.45 to about 1 may be particularly effective at avoiding cracking in the bushing.

Based on all the foregoing, the inventors have not only found ratios which enable a bushing 150 to be manufactured with longer life and improved strength, but they have also been able to devise a combination factor, known herein as a Clarke Factor, which represents a target cumulative score that a bushing 150 constructed in accordance with the teachings of this disclosure should have. The Clarke Factor is mathematically represented as follows:

C_{f}=(C_{w}+C_{d})/BWₜ;
wherein:
   C_{f} is the Clarke Factor;
   C_{W} is the annular cavity width;
   Cd is the annular cavity depth; and
   BWₜ is the bushing wall thickness.

In order for the bushing 150 to work most effectively, the Clarke Factor should be less than about 1. In the specific embodiment identified above, the Clarke Factor was 0.70845, but in alternative embodiments, a range of about 0.5 to about 1 is particularly advantageous, with a range above or below those values still being effective, but losing their strength as the Clarke Factor extends above 1, and losing sufficient lubrication as the Clarke Factor drops below 0.5. For frame of reference, the prior art bushing depicted in FIG. 5 tested out to have a Clarke Factor of 3.1975.

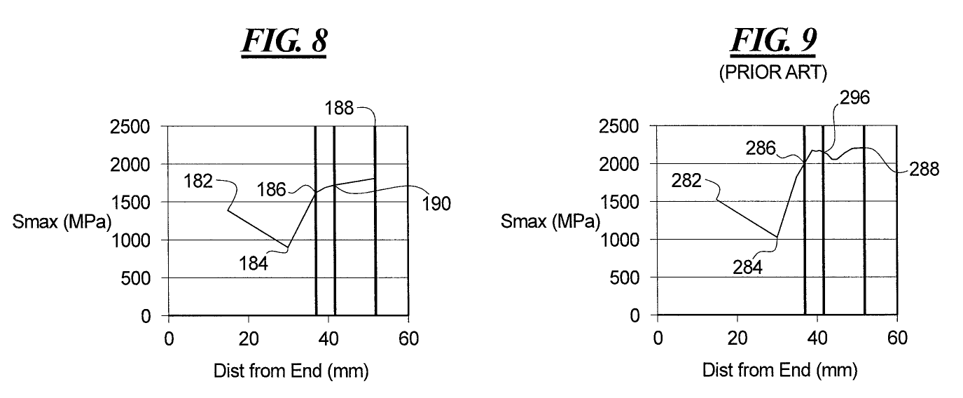

The results of this disclosure are perhaps most dramatically depicted in a comparison of the two stress charts of FIGS. 8 and 9. FIG. 8 depicts the stress concentrations on various locations of a bushing 150 subjected to a test load. For purposes of illustration, a test load of 760 kN was applied to the bushing 150 at five different locations along the length 180 of the bushing. As shown in FIG. 6, those five locations were: 15 mm from the end of the bushing (position 182 in FIG. 6); 30 mm from the end (position 184); at the start of the transition into the annular cavity (position 186); at the center of the bushing (position 188); and at the end of the transition of the annular cavity (position 190). The graph depicts that the maximum stress was encountered at the center line 188 with a measured stress of about 1800 MPa. The minimum stress was at 30 mm from the end (position 184), with a measured stress of about 900 MPa. This compares very favorably to the stress encountered with the prior art bushing of FIG. 5. As shown in its chart in FIG. 9, the maximum stress was again encountered at the center line, but that stress was much higher being measured at about 2300 MPa. Similarly, the minimum stress was encountered at 30 mm from the end of the bushing, but it too was elevated compared to the current disclosure, coming in with a measured stress of about 1100 MPa. On average, the bushing of the present disclosure displayed about a twenty percent reduction in measured stress for the same diameter bushing. In operating terms, this means the bushing of the present disclosure is stronger, less susceptible to cracking, and thus longer-lasting.

### INDUSTRIAL APPLICABILITY

The technology disclosed herein has industrial applicability in a variety of settings such as, but not limited to, bushings used in connecting the shoes of track for a track-type tractor. The track-type tractor may be, but is not limited to, a track-type loader, excavator, or pipelayer. Using the teachings of the present disclosure, the bushing is able to be manufactured with the same outer and inner diameter as prior art bushing, but have significantly improved strength, and thus longer life, than prior art bushings.

The bushings of the present disclosure do so by precisely machining the lubrication cavity on the inner diameter of the bushing so as to be of a specific ratio relative to other dimensions of the bushing or track. Those ratios include cavity width to bushing wall thickness, cavity depth to bushing wall thickness, cavity width to bushing outer diameter, cavity depth to bushing inner diameter, and cavity width to track pin lubrication channel diameter.

Moreover, combining these ratios yields the identified Clarke Factor to provide manufacturers with a singular value or tolerance to which such bushings should be fabricated. If the bushings are so manufactured, they will have improved strength compared to comparably sized prior art bushings and thus will not be as susceptible to cracking under load. This is of significant importance with modern track-type tractors which may operate with Center Track Idlers, or otherwise higher than conventionally encountered loads. The ultimate result of these teachings will therefore result in less downtime for the track-type tractor, increased serviceable life for the machine, and more profitable productivity over the course of its operation.

What is claimed is:

1. A bushing (150), comprising:
a hollow cylindrical wall (163) having an inner diameter (166) and an outer diameter (176); and
an annular cavity (164) extending circumferentially around the inner diameter (166) of the cylindrical wall (163), the cylindrical wall (163) having a thickness (174) of A and the annular cavity (164) having a width (170) of B, the ratio of A to B being at least about 1 or more to about 1.

2. The bushing (150) of claim 1, wherein the A to B ratio is about 1.5 to about 1.

3. The bushing (150) of claim 1, wherein the annular cavity (164) has a depth (172) of C, and the ratio of A to C is at least about 15 to about 1.

4. The bushing (150) of claim 3, wherein the ratio of A to C is about 30 to about 1.

5. The bushing (150) of claim 3, wherein the ratio of B to C is about 30 or less to about 1.

6. The bushing (150) of claim 5, wherein the ratio of B to C is about 20 to about 1.

7. The bushing (150) of claim 1, wherein the cylindrical wall (163) has an outer diameter (176) of D and an inner diameter (166) of E, the ratio of D to B being at least about 2 to about 1.

8. The bushing (150) of claim 7, wherein the ratio of D to B is about 7.5 to about 1.

9. The bushing (150) of claim 7, wherein the ratio of E to B is at least about 2 to about 1.

10. The bushing (150) of claim 7, wherein the ratio of E to B is about 4.5 to about 1.

11. The bushing (150) of claim 1, wherein the annular cavity (164) has a depth (172) of C, the cylindrical wall (163) has an outer diameter (176) of D, and the cylindrical wall (163) has an inner diameter (166) of E, and wherein the ratio of D to C is at least about 50 to about 1.

12. The bushing (150) of claim 11, wherein the ratio of D to C is about 150 to about 1.

13. The bushing (150) of claim 11, wherein the ratio of E to C is at least 50 to about 1.

14. The bushing (150) of claim 13, wherein the ratio of E to C is about 100 to about 1.

15. The bushing (150) of claim 1, wherein the bushing (150) has a length (180) of F, and the ratio of F to B is about 5 or more to about 1.

16. The bushing (150) of claim 15, wherein the ratio of F to B is about 9.45 to about 1.

17. A bushing (150) having a hollow cylindrical wall (163) with an inner diameter (166), an outer diameter (176), and an annular lubrication cavity (164), the bushing (150) having a Clarke Factor of less than about 1.

18. A track-type tractor (100), comprising:
a chassis (102);
an engine (104) supported by the chassis (102);
an undercarriage (118) supporting the chassis (102), the undercarriage (118) including at least one rotatable track (120) operatively connected to the engine (104), the track (120) including a plurality of shoes (132);
a plurality of track pins (144) linking the shoes (132) together, each track pin (144) including a substantially cylindrical housing (154) having a central reservoir (156) and a lubrication channel (160) extending through the housing (154); and
a bushing (150) surrounding each track pin (144), each bushing (150) including a substantially cylindrical housing (163) having an annular cavity (164) on an inner diameter (166), the bushing (150) have a length (180) of F and the annular cavity (164) having a width (170) of B, the ratio of F to B being about 5 or more to about 1.

19. The track-type tractor (100) of claim 18, wherein the track pin lubrication channel (160) has a diameter of G, and the ratio of B to G is about 2 or less to 1.

20. The track-type tractor (100) of claim 19, wherein the bushing (150) has a Clarke Factor of less than about 1.
